(19) United States
(12) Patent Application Publication
(10) Pub. No.: US 2008/0275923 A1
(43) Pub. Date: Nov. 6, 2008

(54) METHOD FOR THE EXPUNGEMENT OF BACKUP VERSIONS OF FILES ON SERVER TARGETS THAT ARE CONFIGURED TO BE UPDATED SEQUENTIALLY

(75) Inventors: William R. Haselton, Nashua, NH (US); Avishai H. Hochberg, San Jose, CA (US); Kevin M. Stearns, Maynard, MA (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/743,214

(22) Filed: May 2, 2007

(51) Int. Cl. G06F 12/00

(52) U.S. Cl. 707/204; 707/E17.005

(57) ABSTRACT

The present invention relates to a method for expunging backup versions of files that are stored at target servers, wherein the target servers are configured to be sequentially updated. The method comprises uploading a predetermined base file to a backup target server from a backup client, uploading a plurality of delta files to the backup target server from the backup client, and determining the chronological order in which the delta riles were uploaded to the backup target server. The method further comprises determining a set of chronologically oldest delta files, downloading the set of chronologically oldest delta files to the backup client, and merging the downloaded chronologically oldest delta files into a single delta file. Yet further, the method comprises uploading the merged delta file to the target server, and deleting the determined set of chronologically oldest delta files at the target server.

### BACKGROUND OF THE INVENTION

1. Field of the Invention

This invention relates to the field of backup storage and retrieval of data files, and particularly to the monitoring and expunging of backup versions of a file on sequentially updated target servers.

2. Description of Background

Conventionally, client file backup applications send information that is necessary to restore a file to the condition it was in at some point in time to a remote server. As such, remote servers are typically in communication with the client over a network connection that may have limited bandwidth. Further, the amount of storage a remote server is configured to provide to a client for maintaining backup files may also be limited. Known solutions to this problem include the operations of backing up an entire file, backing up the progressive delta files that are associated with a file, and backing up the incremental delta files that are associated with a tile. These know solutions are explained as follows.

### Backing Up an Entire File

Backing up an entire file requires that the entire content of a file be transmitted to a target server in the event that a backup file is made. This solution makes no attempt to monitor or conserve network bandwidth. Further, for this technique a restore operation consists of copying the entire file back from the target server storage. Additionally, target server storage space management for this technique involves the deleting of old versions of the file from the target server.

### Backing-Up of Progressive Deltas

For this solution when a file is initially backed-up to a target server, the entire contents of the file is transmitted to the target server, thus establishing a “base” version of the backed-up file. In subsequent file backup operations, file data that is sent to the target server will contain all of the changes that have been made to the file since the base version was established. This new file data contains the “progressive delta,” that is, all of the changes that have been made to the file made since the transmittal of the base version to the target server. Although this technique conserves network bandwidth during a backup operation, when compared to the above-solution of backing up an entire file, a result of the present solution is that redundant changes will be transmitted each time a file backup is stored at the target server. In the event that a past version of a file needs to be recovered, the client simply restores the base version of the file and the progressive delta that is associated with the file. Additionally, any progressive delta that is associated with the file can be deleted to recover space from the target server without affecting a file restore operation (i.e., except the ability to recover a file to a specific point in time that is represented by the progressive delta that has been deleted is lost).

### Backing-Up of Incremental Delta

Similar to the progressive delta backup solution, the incremental delta backup solution also transmits a version of a base file to the target server. Thus, when a file is initially backed-up the contents of the file is sent to the target server. In subsequent file backup operations the file data sent to the target server contains only the changes that have been made to the file since the last backup was performed. The data contained in these subsequent backup operations is referred to as the “incremental delta.” This solution conserves more bandwidth during a file backup operation than both the progressive delta and entire file backup the solutions. Further, in the event that a past version of a file needs to be recovered, the backup client restores the base version and each incremental delta up to the point in time that the backup client needs to reconstruct the file. Optionally, the client can cache the incremental delta or even the base version locally and avoid using excessive amounts of network bandwidth during a file restore operation.

Presently, there exists a need for a solution that allows for the creation and storage of backup file versions, wherein storage capacity limitations and network bandwidth transmittal rates are taken into account in order to optimize file backup operations.

### SUMMARY OF THE INVENTION

The shortcomings of the prior art are overcome and additional advantages are provided through the provision of a method for expunging backup versions of files that are stored at target servers, wherein the target servers are configured to be sequentially updated. The method comprises uploading a predetermined base file to a backup target server from a backup client, uploading a plurality of delta files to the backup target server from the backup client, wherein the delta files are associated with the base file, and determining the chronological order in which the delta files were uploaded to the backup target server. The method further comprises determining a set of chronologically oldest delta files, downloading the set of chronologically oldest delta files to the backup client, and merging the downloaded chronologically oldest delta files into a single delta file. Yet further, the method comprises uploading the merged delta file to the target server, and deleting the determined set of chronologically oldest delta files at the target, server.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of aspects of a system for expunging backup versions of files that are stored at target servers.

FIGS. 2A-12 illustrate one example of a method for expunging backup versions of files that are stored at target servers.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art.

Glossary
Version—Represents the data contained in a file at the point of time in the base when the version was created. Each time a file is backed up a new version is created.
Target server—The target server being used to store the backups of a file and its versions. The target server can comprise, but is not limited to, a file server, a Tivoli Storage Manager Server (TSM), a http server, or a ftp server.
Backup client—The application responsible for moving data between the client and the target server.
Expunge—The process a backup client goes through to reduce the amount of storage used up by backed up versions,
Non-Sequential updates—The capability of a target server to allow a client to update portions of an existing backup.
Base Version—The initial backup of a file.
Incremental Delta—Each delta contains only the changes since the previous delta (or the base version) was created.
Progressive Delta—Each delta contains all the information from the previous deltas.

Within aspects of the present invention a backup client is allowed to manage the amount of storage taken up by multiple past versions of a file on a target server, where the target server only offers the ability for a backup client to create new files and send their data sequentially from beginning to end. For the purposes of this file backup creation technique the deleting of an incremental delta file does not provide an advantageous method to manage stored files. The deletion of an incremental delta will leave the backup operation in a state where only the base version and any incremental deltas created after the base version up to the one that was deleted can be used to restore past version. Additionally, any further backups will require a new base version to be sent to the remote server.

More efficient file storage management techniques involve the solutions of applying the oldest incremental delta to the base version or the merging of a predetermined set of the oldest incremental delta data files (e.g., a set of two data files) and subsequently deleting the oldest data file. As such, the solution of applying the oldest incremental delta to the base version involves taking the data of the oldest delta file and applying the file data to the base version. The result of this action is that the file data and offsets contained in the oldest delta file overwrite the data at the same offsets in the base version. The solution of merging a set of the oldest incremental deltas and deleting the oldest involves taking the data from the a set of the oldest delta files and merging the data into a single file, thereafter eliminating any duplicate delta files in the process. Aspects of the secondary solution are presented within embodiments of the present invention.

Conventionally, remote storage (target) servers are provided in two varieties. A particular type of remote server serves the purpose of a mounted file system. Thus, in the event that a remote server is configured to operate as a mounted file system any file existing within the server can be opened for write operations, further, any data contained at any offset within a file can be modified and saved by a backup client. A secondary type of remote server only supports the sequential writing of entire files; therefore, a backup client cannot modify files existing on these servers in any manner. Examples of these particular kinds of servers comprise, but are not limited to: http servers (e.g., a http server that does not support content range updates), a ftp server, and a TSM server. For servers that only support sequential updating the storage management technique where the oldest incremental delta is applied to the base version cannot be accomplished directly on the server. The result being either storing many deltas based on the same image, and thus potentially violating storage space requirements at the remote server or periodically sending a new base, and thus potentially violating storage space and network bandwidth transmission requirements.

Within aspects of the present invention multiple past versions of a tile can be stored on a target server. Additionally a target server can be configured to store an entire file or simply the changes (delta files) made since the file was last backed up. Target servers utilized within embodiments of the present invention are configured to limit the amount of storage space that a backup client is allotted to use. Further, backup clients are configured to manage the amount of storage that a backup client can use on a server. Additionally, within further aspects of the present invention, backup clients may encrypt or compress the file data that it backs up.

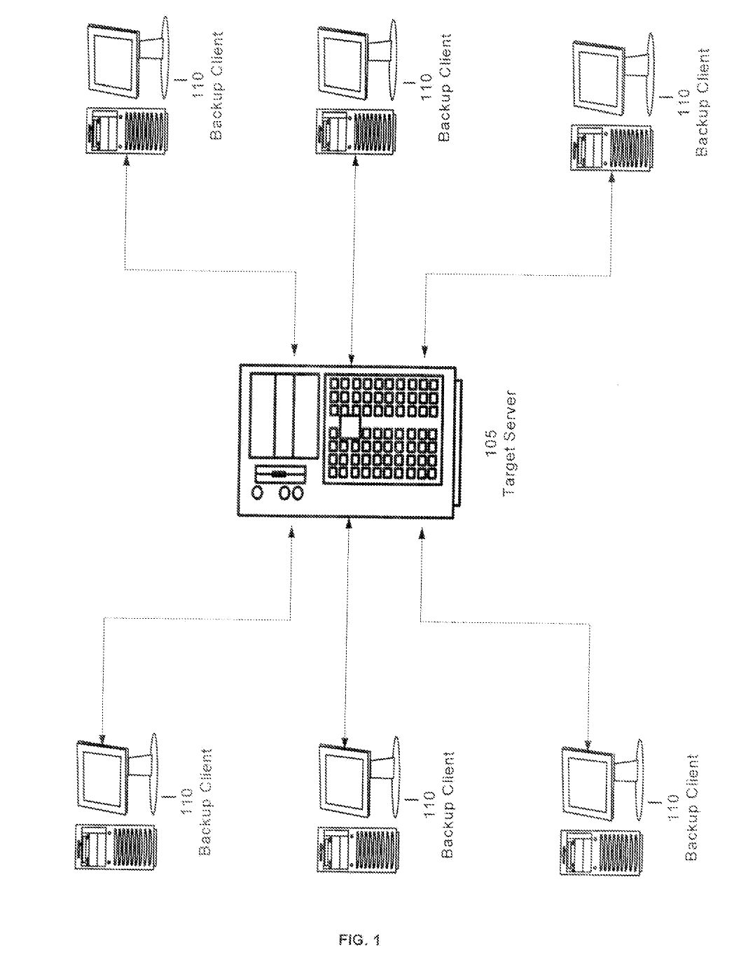

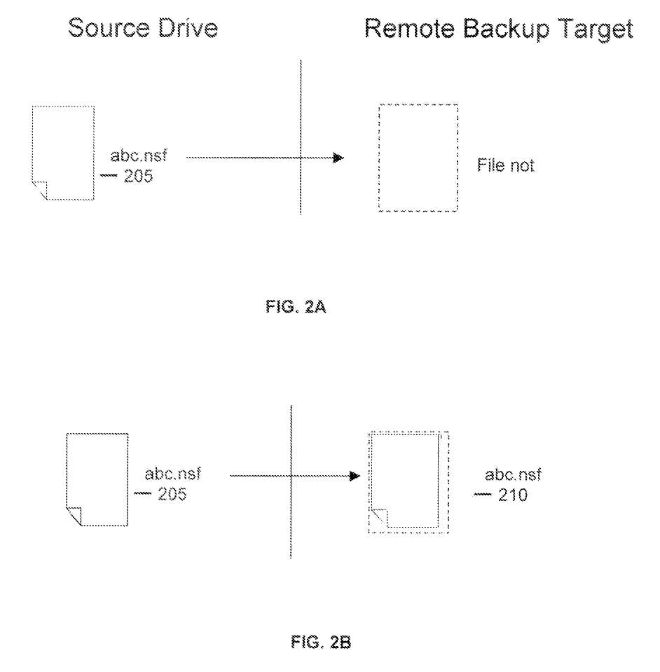

Turning now to the drawings in greater detail, it will, be seen in FIG. 1 there is shown the configuration for a system for expunging backup versions of files that are stored at a target server 105. Using conventional means, the target server 105 is in network communication with a plurality of backup clients 110. FIGS. 2A-12 illustrate a method for expunging backup versions of files that are stored at a target server 105. As shown in FIG. 2A, a file (abc.nsf 205) is saved to a source drive of a backup client 110. At FIG. 2B, the file abc.nsf 205 is transmitted to a remote backup target server 105 for storage at the target server. The version of the file abc.nsf 205 that is saved at the target server 105 is established as the backup base version (abc.nsf 210) of the file abc.nsf 205.

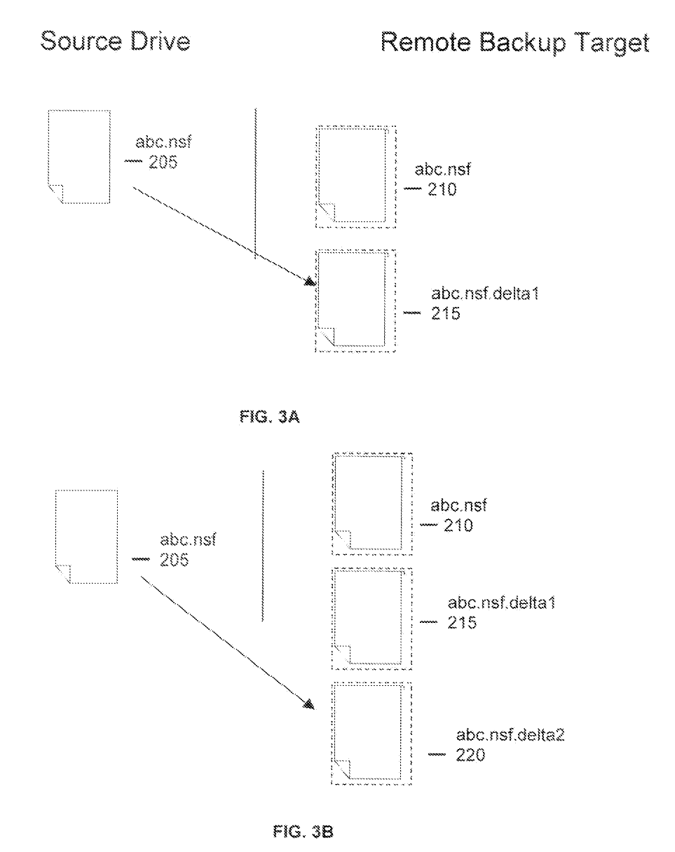

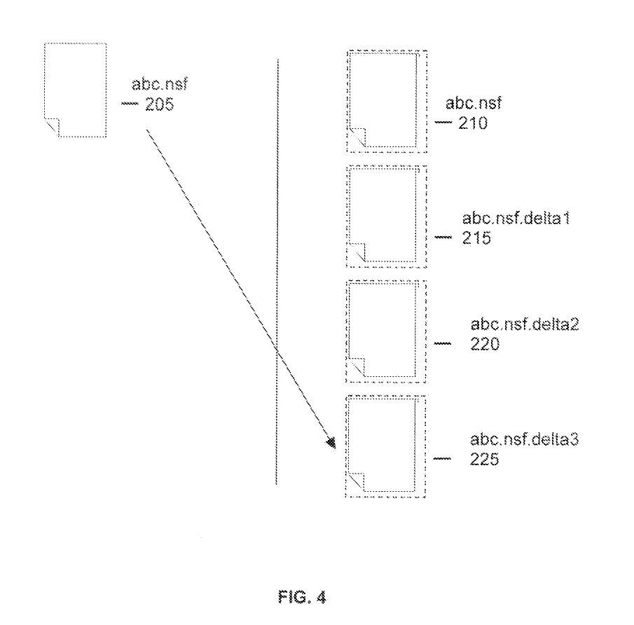

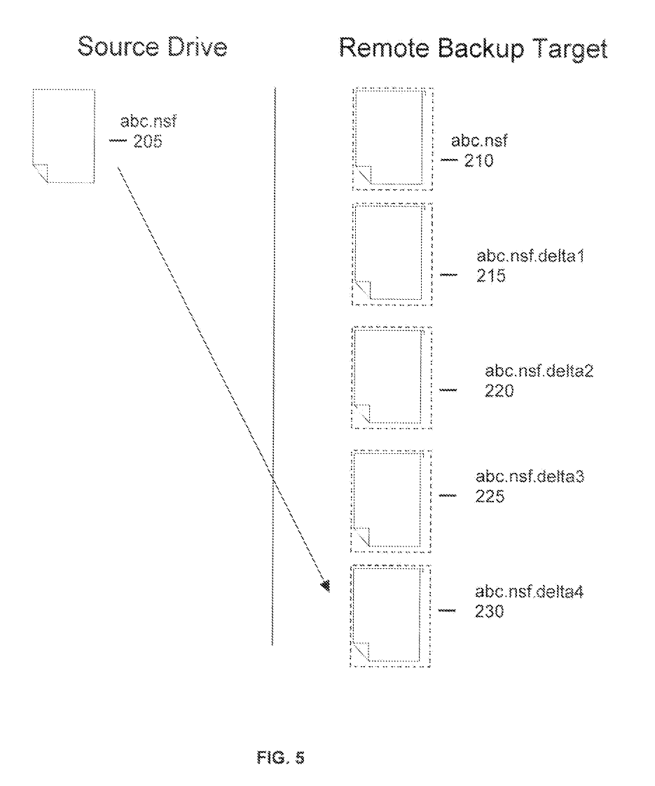

An incremental delta file (abc.nsf.delta1 215) of the backup client file abc.nsf 205 is generated and uploaded from a backup client 110 to the remote target server 105 (FIG. 3A). A secondary incremental delta file (abc.nsf.delta2 220) is generated and uploaded to the target server 105 in FIG. 3B. Further, a third (abc.nsf.delta3 225) and fourth (abc.nsf.delta4 230) are generated and uploaded to the target server 105 in FIGS. 4 and 5, respectively.

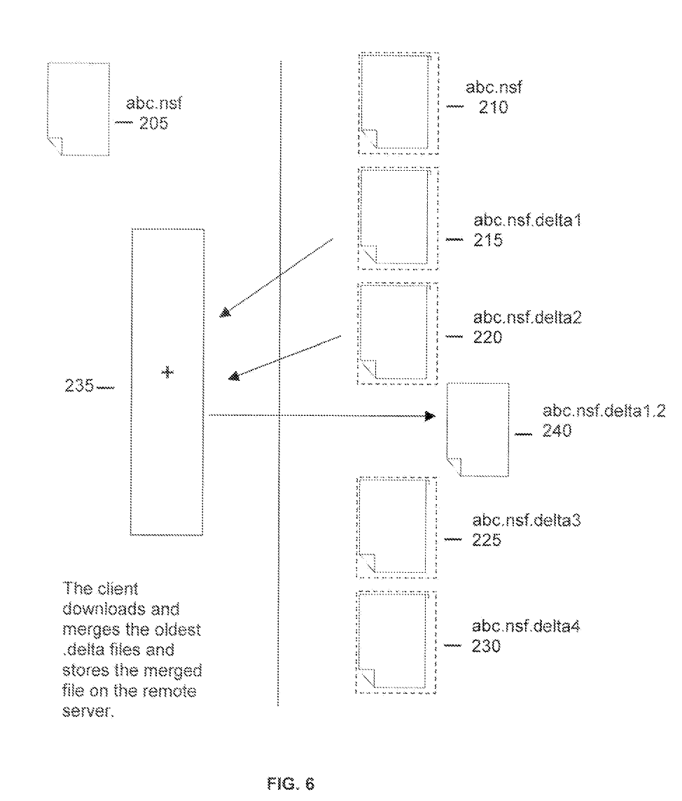

Within aspects of the present invention, the backup client 110 is configured to monitor the storage capacity of the target server 105 in addition to the keeping track of the number of incremental delta files that have been transmitted to and saved at the target server 105. The backup client 110 can be configured to initiate a delta file merger operation in the event that the storage capacity that is allotted to the backup client 110 has encroached into a predetermined range (e.g., the backup client 110 has used or exceeded 80% of its allotted storage capacity at the target server 105) or in the instance that a predetermined amount of delta files has been generated and saved at the target server 105. As shown in FIG. 6, in this instance four delta files (210, 215, 220, and 230) have been saved at the target server 105. In this case, a delta file merger operation is initiated by the backup client 110 when it has determined that there at least two past versions of an incremental delta file.

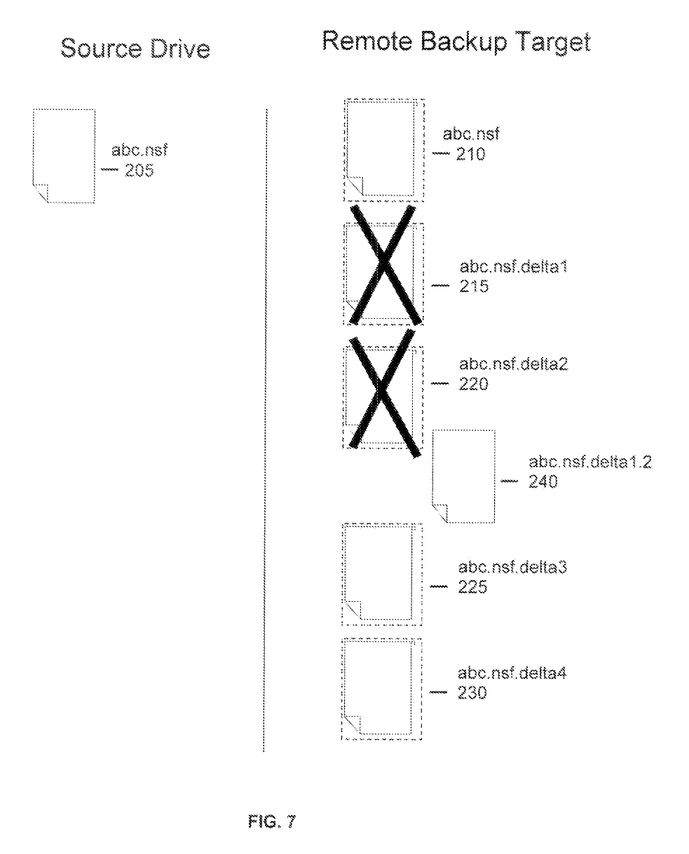

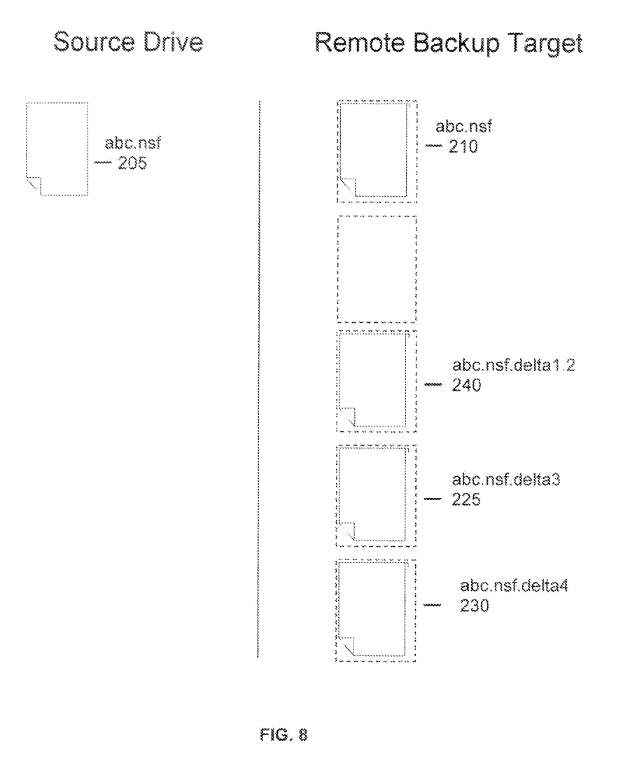

The backup client 110 downloads the two oldest delta files (215, 220) and merges the delta files (215, 220) into a new delta file (235). The delta files are combined in a manner that eliminates any duplicate information from being saved within the newly created delta file (235). Next, the backup client 110 uploads the newly created delta file to the target server 105 for storage as abc.nsf.delta1.2 240. The backup client 110 then deletes the two oldest delta files (215, 220) saved at the target server 105 once they have been replaced with the newly created delta file (240) (FIGS. 7 and 8).

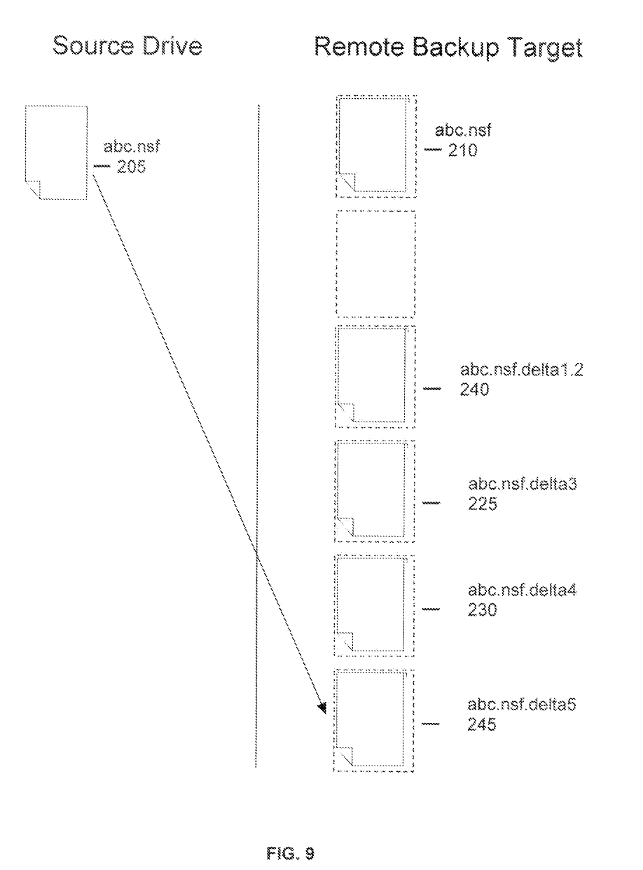

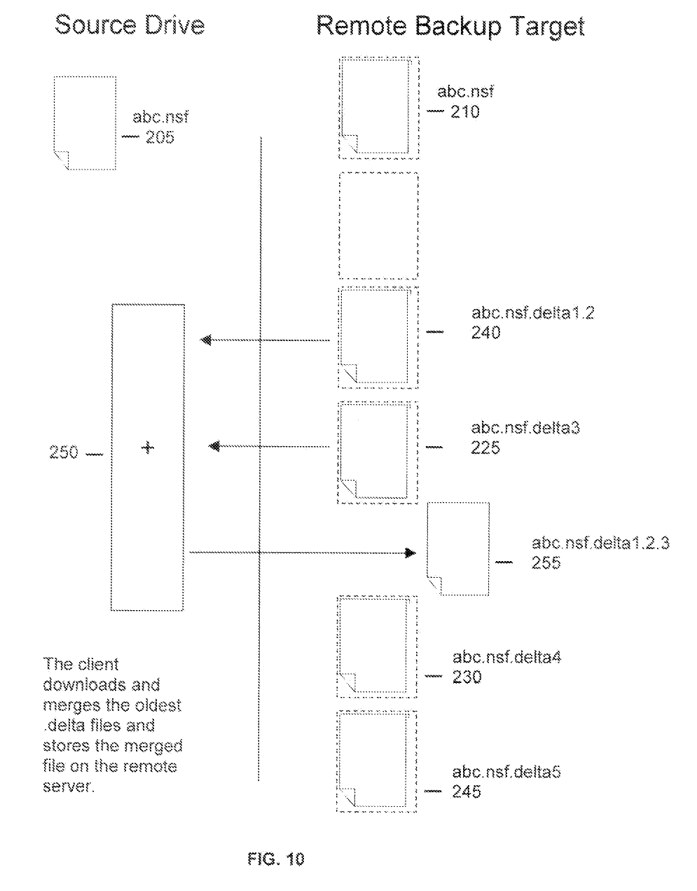

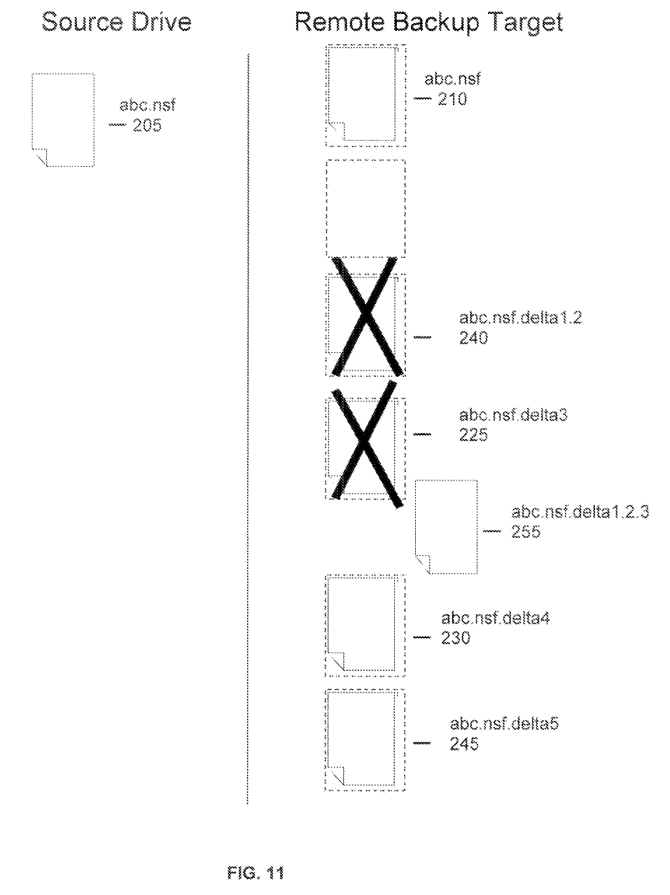

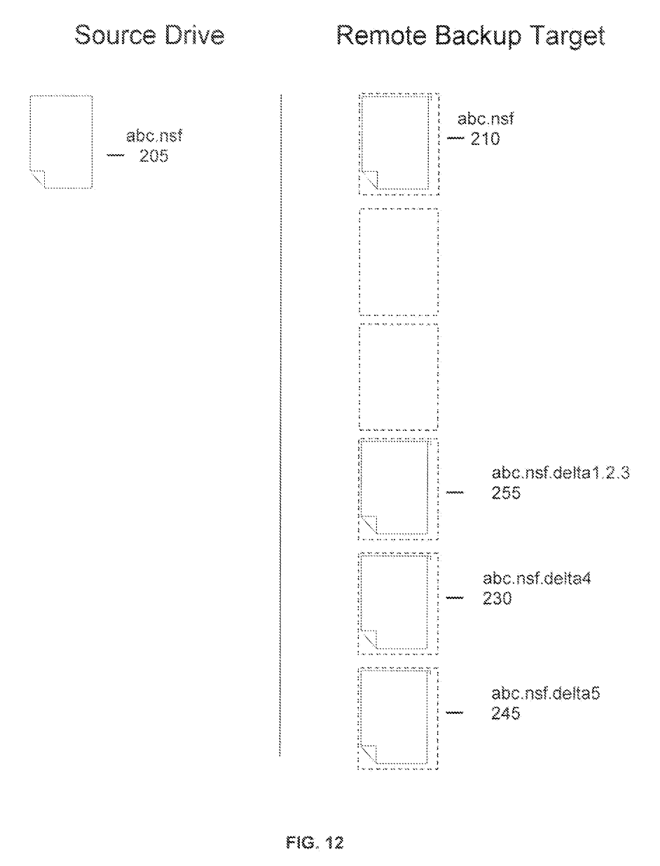

At FIG. 9, a new delta file (abc.nsf.delta5 245) is transmitted from the backup client 110 to the target server 105 for storage. Since in this instance the backup client is configured to combine/merge the two oldest delta files, the delta files abe.nsf.delta1.2 240 and abc.nsf.delta3 225 are selected for the delta file merger operation. As shown in FIG. 10, the delta files abc.nsf.delta1.2 240 and abc.nsf.delta3 225 are downloaded to the backup client 110. The delta files (225, 240) are merged into a new delta file (250) and subsequently uploaded to the target server 105 for storage as abc.nsf.delta1.2.3 255. As descried above, the backup client 110 deletes the two oldest delta files (225, 240) saved at the target server 105 once they have been replaced with the newly created delta file (255) (FIGS. 11 and 12).

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as apart of a computer system or sold separately.

Additionally, at least one program storage device readable by a machine, tangibly embodying at least one program of instructions executable by the machine to perform the capabilities of the present invention can be provided.

While the preferred embodiment to the invention has been described, it will be understood that those skilled in the art, both now and in the future, may make various improvements and enhancements which tall within the scope of the claims which follow. These claims should be construed to maintain the proper protection for the invention first described.

What is claimed:

1. A method for expunging backup versions of files that are stored at target servers, wherein the target servers are configured to be sequentially updated, the method comprising:
uploading a predetermined base file to a backup target server from a backup client;
uploading a plurality of delta tiles to the backup target server from the backup client, wherein the delta files are associated with the base file;
determining the chronological order in which the delta files were uploaded to the backup target server;
determining a set of chronologically oldest delta files;
downloading the set of chronologically oldest delta files to the backup client;
merging the downloaded chronologically oldest delta files into a single delta file;
uploading the merged delta file to the target server; and
deleting the determined set of chronologically oldest delta tiles at the target server.

2. The method of claim 1, wherein base files are uploaded to the backup target server from at least two back up clients.

3. The method of claim 1, wherein at least two delta files are merged into a single delta file.

4. The method of claim 1, wherein the backup target servers comprise a http server, a ftp server, or a Tivoli Storage Manager (TSM) server.

5. The method of claim 1, wherein the base file and the delta files are encrypted by the backup client prior to the uploading of the files to the backup target server.

6. The method of claim 1, wherein the base file and the delta files are compressed by the backup client prior to the uploading of the files to the backup target server.

7. The method of claim 1, wherein the backup client uploads a delta file to the target server in accordance with a predetermined scheduled interval.

8. The method of claim 7, wherein the backup client monitors the amount of storage space that it utilizes on the backup target server, where in the event that the storage capacity allotted to the backup client at the backup target server is determined to be at or above a predetermined amount the backup client will download a determined set of the chronologically oldest delta files.

9. A system for expunging backup versions of files that are stored at target servers, wherein the target servers are configured to be sequentially updated, the system comprising:
a target server, wherein the target server further comprises a storage medium;
at least one backup client in communication with the target server, the backup client further comprising a storage medium, wherein the backup client is further configured to:
upload a predetermined base file and a plurality of delta files to a backup target server;
determine the chronological order in which the delta files were uploaded to the backup target server;
determine a set of chronologically oldest delta files;
download the determined set of chronologically oldest delta files from the target server; and
merge the downloaded chronologically oldest delta files into a single delta file.

10. The system of claim 9, wherein the backup client is further configured to upload the merged delta file to the target server.

11. The system of claim 10, wherein the predetermined set of the chronologically oldest delta files is deleted at the target server upon the completion of the merged delta file upload operation.

12. The system of claim 11, wherein at least two delta files are merged into a single delta file.

13. The system of claim 11, wherein the backup target servers comprise a http server, a ftp server, or a Tivoli Storage Manager (TSM) server.

14. The system of claim 11, wherein the base file and the delta files are encrypted by the backup client prior to the uploading of the files to the backup target server.

15. The system of claim 11, wherein the base file and the delta files are compressed by the backup client prior to the uploading of the files to the backup target server.

16. The system of claim 11, wherein the backup client uploads a delta file to the target server in accordance with a predetermined scheduled interval.

17. The system of claim 11, wherein the backup client monitors the amount of storage space that it utilizes on the backup target server, where in the event that the storage capacity allotted to the backup client at the backup target server is determined to be at or above a predetermined amount the backup client will download a predetermined set of the chronologically oldest delta files.

18. A computer program product that includes a computer readable medium useable by a processor, the medium having stored thereon a sequence of instructions which, when executed by the processor, causes the processor expunge backup versions of delta files that are stored at target servers by:
uploading a predetermined base file to a backup target server from a backup client;
uploading a plurality of delta files to the backup target server from the backup client, wherein the delta files are associated with the base file;
determining the chronological order in which the delta files were uploaded to the backup target server;
determining a set of chronologically oldest delta files;
downloading the set of chronologically oldest delta files to the backup client;
merging the downloaded chronologically oldest delta files into a single delta file;
uploading the merged delta file to the target server; and
deleting the determined set of chronologically oldest delta files at the target server.

19. The computer program product of claim 18, wherein the backup client uploads a delta file to the target server in accordance with a predetermined scheduled interval.

20. The computer program product of claim 18, wherein the backup client monitors the amount of storage space that it utilizes on the backup target server, where in the event that the storage capacity allotted to the backup client at the backup target server is determined to be at or above a predetermined amount the backup client will download a determined set of the chronologically oldest delta files.
